(19) United States
(12) Patent Application Publication
(10) Pub. No.: US 2006/0233665 A1
(43) Pub. Date: Oct. 19, 2006

(54) Test chip and test chip system

(76) Inventors: Yasuhiko Sasaki, Tsuchiura (JP); Osamu Kogi, Yokohama (JP); Hiroshi Kishida, Kawasaki (JP); Toru Inaba, Tokyo (JP); Masaomi Uchida, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/327,481

(22) Filed: Jan. 9, 2006

(30) Foreign Application Priority Data
Apr. 15, 2005 (JP) 2005-118439

(51) Int. Cl. B01L 3/00

(52) U.S. Cl. 422/61

(57) ABSTRACT

A test chip, which allows a number of solution delivery steps much faster and accurate is provided. The test chip incorporates a sample flow path for containing a sample solution, a reaction flow path for inducing a predetermined reaction with the sample solution, a waste drain path for receiving the used sample, and the washing solution flow paths for containing washing solutions. The reaction flow path contains a plurality of beads having probes of mutually different types fixed thereon. The sample flow path, washing solution flow paths, and sample waste drain path have their respective solution detector units. The solution detector unit detects whether the solution is fed to the path. The detector units adjoiningly provided in the adjacent paths are arranged collinearly.

### FIELD OF THE INVENTION

The present invention is related to a test chip and a test chip system using the same for detecting such biological materials as peptides, proteins, DNAs, and RNAs.

### BACKGROUND OF THE INVENTION

Base sequence of human genome has been completely decoded and there are active efforts to understand a living organism in its DNA level, and to make use thereof in the understanding of vital phenomenon and in the diagnosis of diseases. To achieve this, important is the simultaneous discrimination of a plurality of genotypes and differences of genetic expression status in the cell in order to compare between diseases or individuals. As a potentially dominant method for examining the genetic expression status, a probe chip in which a number of probes on a solid surface such as including a slide glass is classified into some types, or DNA chip, or a protein chip is used.

The involving manufacturing technique of such chips includes a method which has been disclosed in Science 251, 767-773 (1991), in which photochemical reaction and the lithography technique commonly used in the semiconductor industry are used to synthesize a base of oligomer of the sequence of predetermined design one by one on a number of cells partitioned on a slide glass, and another method disclosed in Anal. Chem. 69, 543-551 (1997) in which a plurality of types of probes is implanted one by one to each partition.

There has been presented a method disclosed in JP-A-H11-243997 (patent reference #1), in which a biological material test chip may be created by providing a number of particles (beads) having probes fixed thereon, and by gathering a few types of beads therefrom. In accordance with this method the probe may be fixed by means of chemical reaction in a solution, resulting in a probe chip with a uniform probe density among beads. This method therefore allows configuring a high precision test chip. The contents of above non-patent and patent disclosures are hereby incorporated by reference into this application.

### SUMMARY OF THE INVENTION

When using the test chip disclosed in the above patent, a number of types of DNAs may be detected at the same time. However, DNA detection requires following a procedure including a number of process steps such as pretreatment, hybridization, washing, and so on. In addition, the numbers and types of rinse solution used in the washing step differ from sample to sample. Thus a number of types of solution must be delivered quickly and accurately.

The present invention has been made in view of the above circumstances and has an object to overcome the above problems and to provide a test chip and a test chip system, which allows delivering a number of types of solution in a precise and prompt manner.

In accordance with the present invention, the test chip comprises a sample flow path for containing a sample solution, a reaction flow path for conducting a predefined reaction with the sample solution, a waste drain path for collecting reacted samples, and a washing solution flow path for containing a rinse solution. A plurality of beads having mutually different types of probes fixed thereon are housed in the reaction flow path.

At one end of the sample flow path, washing solution flow path, and waste drain path, a respective delivery port is provided and the other end thereof is connected to the reaction flow path.

Between each of the sample flow path, the washing solution flow path and waste drain path, and its delivery port, a solution detector unit is provided respectively. The solution detector unit detects whether the solution is delivered into the passageway or not. The solution detector units provided to adjoining paths are placed in line.

For delivering the sample solution into the feeding direction, a pressure is applied to the delivery port connected to the sample flow path while the atmospheric pressure is connected to the delivery port connected to the empty waste drain path and other delivery ports are closed. The sample solution contained in the sample flow path passes through the reaction flow path to move to the waste drain path.

On the other hand, for delivering the sample solution into the return direction, a pressure is applied to the delivery port connected to the waste drain path while the atmospheric pressure is applied to the delivery port connected to the sample flow path and the other delivery ports are closed. The sample solution containing in the waste drain path thereby passes through the reaction flow path to return to the sample flow path.

The solution delivery in the feeding direction and the solution delivery in the return direction are switched based on the signals from the solution detector unit. Once a predetermined number of flows of solutions are completed, and when the sample solution returns to the waste drain path, the delivery of sample solution will be terminated.

For delivering the rinse solution in the feeding direction, a pressure is applied to the delivery port connected to the rinse solution flow path while the atmospheric pressure is applied to the delivery port connected to the empty sample flow path, and any other deliver ports are closed. The rinse solution contained in the rinse solution flow path thereby will pass through the reaction flow path to move to the sample flow path.

On the contrary, for delivering the rinse solution in the return direction, a pressure is applied to the delivery port connected to the sample flow path while the atmospheric pressure is applied to the delivery port connected to the rinse solution flow path, and any other delivery ports are closed. The rinse solution contained in the sample flow path thereby will pass through the reaction flow path to move to the rinse solution flow path. The delivery of solution in the feeding direction and the delivery of solution in the return direction are switched based on the signals from the solution detector unit. Once a predetermined number of flows of solutions is completed and when the rinse solution returns to the sample flow path, the delivery of rinse solution is terminated.

A cover is attached to the test chip. There are two apertures provided in the cover. The cover will be attached so as to align these two apertures with the positions of two corresponding delivery ports. In this manner the delivery ports are applied with a pressure through the cover apertures, or connected to the atmosphere. Any other ports will be closed thereby.

Preferably, at least one of the sample flow path, washing solution flow path, and waste drain path may be formed of PDMS (Polydimethylsiloxane, (C₂H₆SiO)ₙ).

As can be seen from the foregoing, the delivery of a number of flows of solution will be performed promptly and accurately in accordance with the present invention.

### BRIEF DESCRIPTION OF THE DRAWINGS

The accompanying drawings, which are incorporated in and constitute a part of this specification illustrate an embodiment of the invention and, together with the description, serve to explain the objects, advantages and principles of the invention. In the drawings,

FIG. 1 is a schematic diagram of a biological material test system in accordance with the present invention;

FIG. 2 is an exemplary DNA test process;

FIG. 3 is a schematic perspective view indicating the flow path including the beads with probes fixed thereon;

FIG. 4 is an exemplary DNA test process using the test chip in accordance with the present invention;

FIG. 5 is a schematic top plan view of the test chip in accordance with the present invention;

FIG. 6 is a schematic top plan view of the test chip and its cover in accordance with the present invention;

FIG. 7 is a schematic diagram depicting how to conduct a reaction process using the test chip in accordance with the present invention;

FIG. 8 is a schematic diagram depicting how to conduct first washing process using the test chip in accordance with the present invention;

FIG. 9 is a schematic diagram depicting how to conduct second washing process using the test chip in accordance with the present invention;

FIG. 10 is a schematic diagram depicting how to conduct third washing process using the test chip in accordance with the present invention;

FIG. 11 is a schematic diagram depicting how to conduct fourth washing process using the test chip in accordance with the present invention;

FIG. 12 is a schematic diagram illustrating the test chip in accordance with the present invention after fourth washing process and when all test steps are completed.

FIG. 13 is a schematic diagram illustrating a solution detector unit of the test chip in accordance with the present invention;

FIG. 14 is a cross-sectional view of first embodiment of the solution detector unit of the test chip in accordance with the present invention;

FIG. 15 is a cross-sectional view of second embodiment of the solution detector unit of the test chip in accordance with the present invention;

FIG. 16 is a cross-sectional view of third embodiment of the solution detector unit of the test chip in accordance with the present invention;

FIG. 17 is a cross-sectional view of fourth embodiment of the solution detector unit of the test chip in accordance with the present invention;

FIG. 18 is a cross-sectional view of fifth embodiment of the solution detector unit of the test chip in accordance with the present invention;

FIG. 19 is a cross-sectional view of sixth embodiment of the solution detector unit of the test chip in accordance with the present invention;

FIG. 20 is a schematic diagram of the flow control mechanism of a biological material test system in accordance with the preferred embodiment of the present invention; and

FIG. 21 is a flow diagram of the operation of a flow control mechanism of the biological material test chip in accordance with the preferred embodiment of the present invention.

### DETAILED DESCRIPTION OF THE PREFERRED EMBODIMENT

A detailed description of one preferred embodiment embodying the present invention will now be given referring to the accompanying drawings.

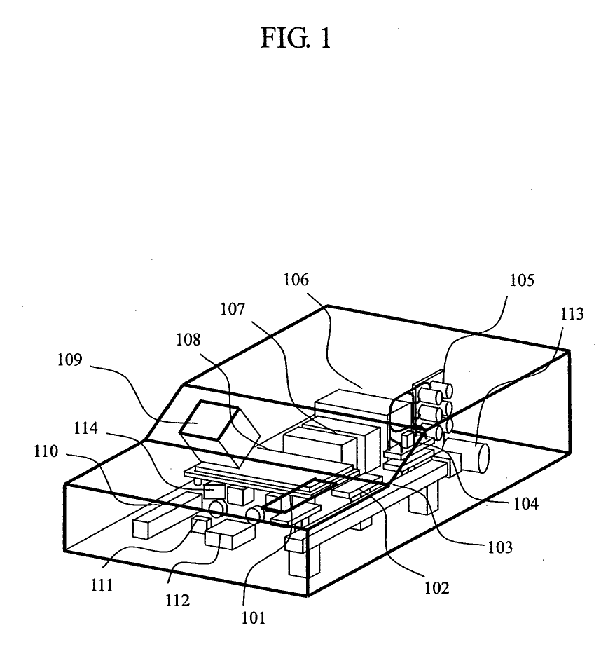

Now referring to FIG. 1, which shows a biological material test system in accordance with the present invention which will be described in greater details. The biological material test system in the preferred embodiment comprises a chip insertion window 101 for inserting a test chip, an optical stage 102 for mounting a test chip for measuring the florescent intensity, a conveying stage 103 for moving the test chip, a reaction stage 104 for mounting a test chip for conducting a hybridization reaction thereon, a valve 105 and a pump 113 for delivering solution into the test chip, a power supply 106, a motor driver 107, a controller board 108, an information access panel 109, and an optics for measuring the florescent intensity. The optics includes a number of optical components including such as a laser light source 110, a collimator lens, a mirror 114, and light receiving elements 111 and 112.

The motor driver 107 and the controller board 108 are used for operating the conveying stage 103, the valve 105, and the pump 113. The power supply 106 supplies electric power to the components. The information access panel 109 is used to input the measurement conditions as well as to output the measurement results.

The biological material test system in accordance with the present invention can detect DNAs, RNAs, proteins, peptides and the like. In the following description an exemplary case of detection of DNAs will be described in greater details.

First, the test chip is inserted through the chip insertion window 101. The test chip contains beads having probes fixed, in addition to a sample including the fluorescent labeled DNA, and washing solution. The detailed description of the structure of the test chip will be described later in this document. Next, the test chip will be transported to the reaction stage 104 by means of the conveying stage 103. On the reaction stage 104 the sample solution including DNA within the test chip will flow through the beads having probes fixed, in order to conduct the hybridization reaction. The hybridization induces a complementary strand binding between DNA fragment contained in the sample and the probe DNA. After hybridization, beads are washed with a plurality of types of rinse solutions to eliminate unreacted DNAs. The sample solution and rinse solution are delivered by operating the syringe pump 113 and the valve 105. The detailed description of solution delivery will be described in greater details later.

After washing, the conveying stage 103 transports the test chip to the optical stage 102. On the optical stage 102 the laser emitted from a laser light source 110 are collimated by a lens to radiate to the probes. Since DNAs in the sample linked to the probes are fluorescent labeled, DNAs emits fluorescence when radiated by the laser beam. The fluorescent light passes a filter to select a predetermined wavelength range and to be detected by a photodetector. As photodetector, a CCD camera or a photo-multiplexer may be used. The image obtained by the photodetector will be displayed on the information access panel 109.

The beads are arranged along with the flow path in the test chip in apposition. Each bead has a different probe fixed thereon. Therefore the type of probe can be identified by the position of bead in the flow path. The beads also can be fluorescent labeled for the beads location to be detectable. To measure the fluorescence from the beads an APD (avalanche photodiode) may be used as the light receiving element. The APD separates beads' fluorescence from the DNA's fluorescence by means of wavelength. Instead of using the APD, a CCD camera may be used. The CCD camera does not separate the light by means of wavelength as is done by APD, however the CCD can detect the locations of beads. Alternatively a PMT (photo-multiplexer tube), which is much sensitive than the APD, can be used. The light separation by means of wavelength is achievable by using a dichroic mirror.

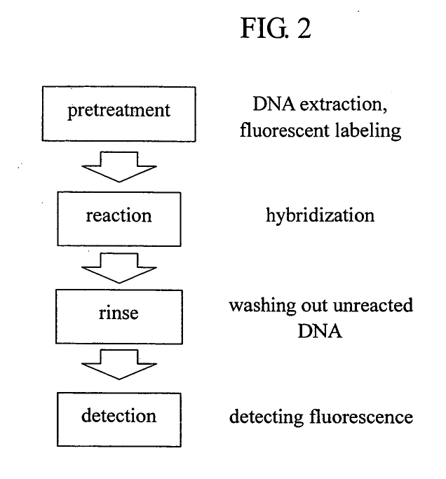

The overview of DNA detection procedure will be described with reference to FIG. 2. The DNA detection procedure includes four steps, namely a pretreatment step, a reaction step, a washing step, and a detection step. In the pretreatment step DNA is extracted from a living organism and is fluorescent labeled. A sample including DNA is prepared in such a manner. In the reaction step, DNA in the sample solution is hybridized with DNA in the probe. In the washing step unreacted DNA is washed out. In the detection step the fluorescence from the DNA trapped by the probe is detected.

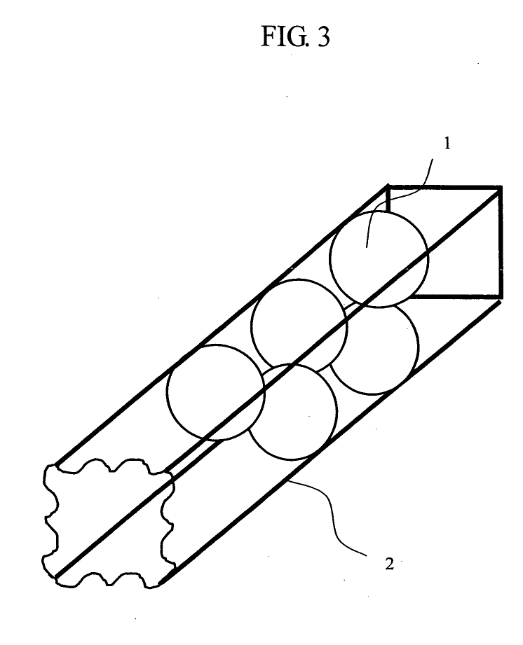

Beads loaded in the test chip will be described with reference to FIG. 3. As is shown in the figure, the beads 1, having probes fixed thereon, are arranged in the reaction flow path 2 formed in the test chip. The manufacturing method of beads 1 is documented in the patent reference #1 cited above and is not further described here. Although in the example shown, spherical beads are filled, a rectangular or any other form of beads can be equally used. The diameter of beads is in the range of approximately 1 to 300 microns, and in this embodiment a spherical beads of diameter of 100 microns is used. The beads may be often made of plastics or glasses, and also made of a metal such as gold. In the example shown the beads of glass will be described.

The retention of beads may be either one-dimensionally or two-dimensionally in the reaction flow path 2. For the sake of clarity one-dimensional retention of beads will be described. In other words, beads are arranged in apposition in a single line in the reaction flow path 2.

The reaction flow path 2 may be a cylindrical passageway in a form of capillary, and is preferably a passageway made from PDMS (polydimethylsiloxane, (C₂H₆SiO)ₙ), a kind of silicone resins, formed on a glass substrate. There are three advantages when using PDMS as the material of flow path: first, once the mold is complete, the formation of flow path is very simple and cost effective; second, unlike the capillary, a flow path of various shape and route can be made, more specifically, a flow path of complex form of shape and section can be made very easily; third, optical characteristics thereof is excellent. More specifically the amount of self-luminous fluorescence is very small so that the error or noise when measuring the fluorescent intensity of DNA becomes smaller. In the following description the reaction flow path 2 is assumed to be formed from PDMS. The possible materials of flow path include, in addition to PDMS, glass, hard resins, and silicone.

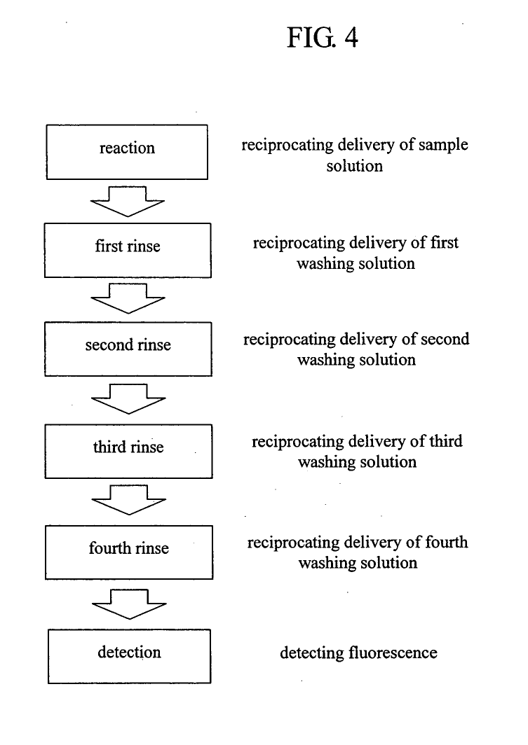

DNA detection procedure by using the test chip in accordance with the present invention will be described in greater details herein below with reference to FIG. 4. Now it is assuming that the pretreatment has been already completed. In the reaction step, the sample solution including DNA is reciprocated through the flow path loaded with beads having probes fixed thereon. This allows DNA in the sample solution and DNA of probe to be hybridized. In the first to fourth washing steps, washing solution is reciprocated through the flow path loaded with beads having probes fixed thereon. The washing step rinses and eliminates any unreacted DNAs. In each of four washing steps a different rinse solution is used. In the detection step a laser beam is emitted to the beads to detect fluorescence from the DNA bound to the probes.

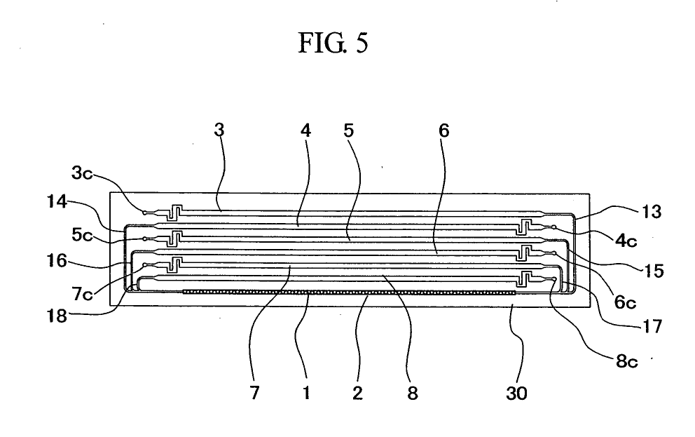

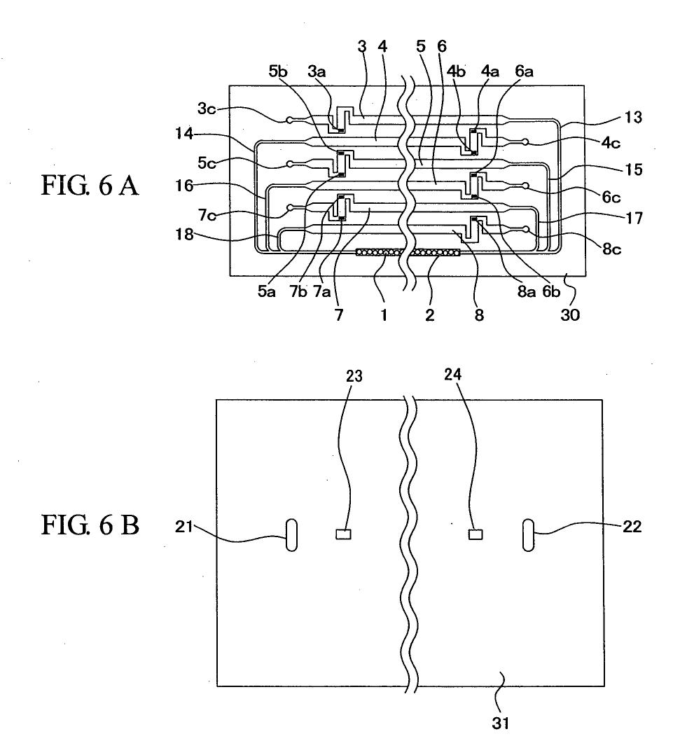

The structure of the test chip 30 in accordance with the present invention will be described in greater details with reference to FIGS. 5 and 6. As shown in FIG. 5, the test chip 30 in accordance with the preferred embodiment incorporates a reaction flow path 2 containing a number of beads 1, a waste drain path 3 for containing used sample solution, a sample flow path 4 for delivering the sample solution, first, second, third, and fourth washing solution flow paths 5, 6, 7, and 8 for respectively containing four types of washing solution, delivery ports 3c and 4c used for feeding sample solution, and delivery ports 5c, 6c, 7c, and 8c used for feeding washing solutions.

The test chip in accordance with the preferred embodiment is configured as shown in FIG. 4 so as to perform four washing steps, therefore has first to fourth washing solution flow path 5, 6, 7, and 8. The same number of washing solution flow paths as the number of types of solution to be used need be provided. The number of types of rinse solutions to be used varies depending on the object to be analyzed. Furthermore, a flow path to perform the pretreatment step as shown in FIG. 2 may be added.

The delivery ports 3c, 5c, and 7c in the left hand side are arranged in one line spaced apart at even intervals. The delivery ports 4c, 6c, and 8c in the right hand side are arranged in one line spaced apart at even intervals.

At the right side end of the reaction flow path 2, there are three passageways 13, 15, and 17 connected thereto, while at the left side end, there are another three passageways 14, 16, and 18 connected thereto. The right side end of the waste drain path 3 is connected to the right side end of the reaction flow path 2 through the passageway 13, the left side end of the sample flow path 4 is connected to the left side end of the reaction flow path 2 through the passageway 14. The right side end of the washing solution flow path 5 for the first washing solution is connected to the right side end of the reaction flow path 2 through the passageway 15; the left side end of the washing solution flow path 6 for the second washing solution is connected to the left side end of the reaction flow path 2 through the passageway 16; the right side end of the washing solution flow path 7 for the third washing solution is connected to the right side end of the reaction flow path 2 through the passageway 17; and the left side end of the washing solution flow path 8 for the fourth washing solution is connected to the left side end of the reaction flow path 2 through the passageway 18.

As shown in FIG. 6A, the passageway between the left side end of the waste drain path 3 and the delivery port 3c has a serpentine section where a solution detector unit 3a is mounted. The passageway between the right side end of the sample flow path 4 and the delivery port 4c has a serpentine section where two solution detector units 4a and 4b are mounted.

The passageway between the left side end of the washing solution flow path 5 for the first rinse solution and the delivery port 5c has a serpentine section where two solution detector units 5a and 5b are mounted. The passageway between the right side end of the washing solution flow path 6 for the second rinse solution and the delivery port 6c has a serpentine section where two solution detector units 6a and 6b are mounted. The passageway between the left side end of the washing solution flow path 7 for the third rinse solution and the delivery port 7c has a serpentine section where two solution detector units 7a and 7b are mounted. The passageway between the washing solution flow path 8 for the fourth rinse solution and the delivery port 8c has a serpentine section where one solution detector unit 8a is mounted.

The positional relationship among those solution detector units will be described. The detector units 3a and 4a are collinearly arranged in line; the detector units 4b and 5b are collinearly arranged in line; the detector units 5a and 6a are collinearly arranged in line; the detector units 6b and 7b are collinearly arranged in line; and the detector units 7a and 8a are collinearly arranged in line. In other words the detector unit placed at the both ends of adjoining paths are collinearly arranged in line.

Now referring to FIG. 6B, which shows the structure of a cover 31 of the test chip 30. The cover 31 has a slightly larger dimension than that of a test chip, so as to be slidable on the test chip 30 when placed over the test chip 30. The cover 31 has two apertures 21 and 22, and two solution sensors 23 and 24. The apertures 21 and 22 are in an elongate shape, the longitudinal dimension of which is slightly larger than the pitch of delivery ports 3c, 5c, 7c, as well as 4c, 6c, and 8c. When the cover 31 is placed over the test chip 30, two delivery ports at the both side are exposed through the apertures 21 and 22. The delivery ports other than the ports exposed through the apertures 21 and 22 are sealed by the cover 31. The delivery ports of the left side are applied with a pressure through the left side aperture 21 or connected to the atmospheric pressure therethrough, and the delivery ports of the right side are connected to an atmospheric pressure through the aperture 22 or applied with a pressure therethrough. This allows the delivery of sample solution or washing solution.

In this arrangement the solution sensors 23 and 24 are placed at the positions corresponding to the locations of two collinearly arranged solution detector units respectively. The solution sensors 23 and 24 detect whether the solution such as sample and washing solutions is present at the detector unit or not. An exemplary embodiment of the structure of solution sensors and detector units will be described in greater details herein below with reference to FIGS. 13 to 19.

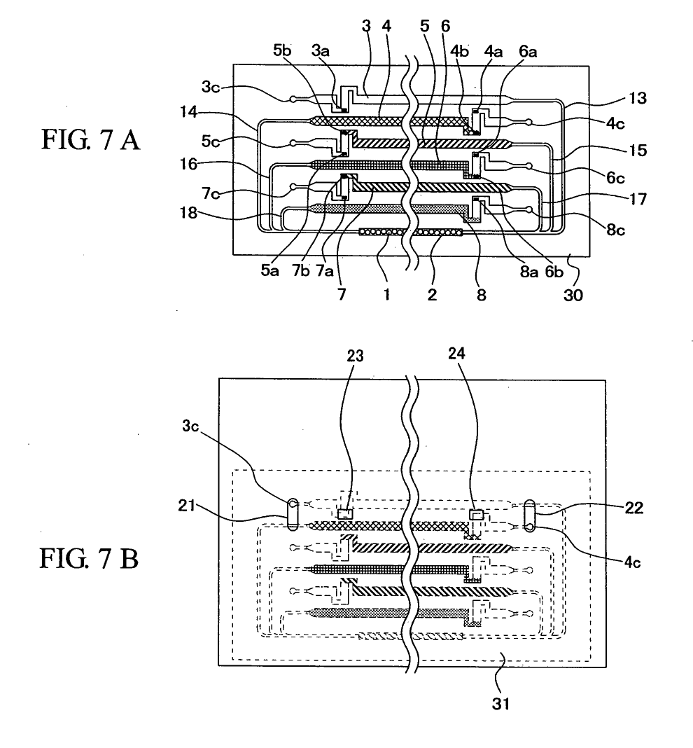

The operation and use of the test chip in accordance with the present invention will be described in greater details now with reference to FIGS. 7, 8, 9, 10, 11, and 12.

Now referring to FIG. 7, the hybridization reaction step will be described. FIG. 7A shows the test chip 30 prior to the hybridization step, and FIG. 7B shows the relative positions of the test chip 30 and the cover 31 in the hybridization, and the test chip 30 in dotted line.

As shown in FIG. 7A, prior to hybridization reaction, the waste drain path 3 is empty, while the sample flow path 4 is filled with a sample. The washing solution flow paths 5, 6, 7, and 8 contains respectively first washing solution, second washing solution, third washing solution, and fourth washing solution. To perform the hybridization reaction step, as shown in FIG. 7B, the cover 31 is relatively moved with respect to the test chip 30 so as to align the delivery ports 3c and 4c with the aperture 21 and 22 on the cover. By doing this other delivery ports 5c, 7c, 6c, and 8c are closed, and the solution sensors 23 and 24 are placed at the positions of solution detector units 3a and 4a.

First, the solution is delivered in the feeding direction. The delivery port 3c is opened to air, the delivery port 4c is applied with a high pressure. The sample solution within the sample flow path 4 passes through the passageway 14 to the reaction flow path 2, then through the passageway 13 to the waste drain path 3.

Next, the solution is delivered in the return direction. Once the sample solution is attained to the solution detector unit 3a located at the left side end of the waste drain path 3, the solution is detected by the solution sensor 23. The solution sensor 23, upon detection of the arrival of sample solution at the solution detector unit 3a, transmits the detection to the syringe pump 113.

The syringe pump 113 switches over the valve 105 to apply a high pressure to the delivery port 3c and to open the delivery port 4c to the air. The sample solution contained in the waste drain path 3 flows back through the passageway 13 to the reaction flow path 2, and then through the passageway 14 to the sample flow path 4.

Next, the solution is delivered in the feeding direction. Upon arrival of the sample solution at the solution detector unit 4a at the right side end of the sample flow path 4, the solution sensor 24 detects the solution. The solution sensor 24, upon detection of the arrival of sample solution at the solution detector unit 4a, transmits the detection to the syringe pump 113.

The syringe pump 113 in turn switches over the valve 105 to apply a high pressure to the delivery port 4c, and to open the delivery port 3c to the air. The sample solution contained in the sample flow path 4 passes through the passageway 14 to the reaction flow path 2, and then through the passageway 13 to the waste drain path 3.

As can be seen, by switching the valve 105, the solution delivery in the feeding direction and in the return direction can be performed alternately by the predetermined number of cycles. This feeds and returns the sample solution through the reaction flow path 2. Each time the sample solution flows through the reaction flow path 2, the DNAs contained in the sample solution hybridize with the probes fixed on the beads. When the sample solution moves to the waste drain path 3 the hybridization reaction step terminates.

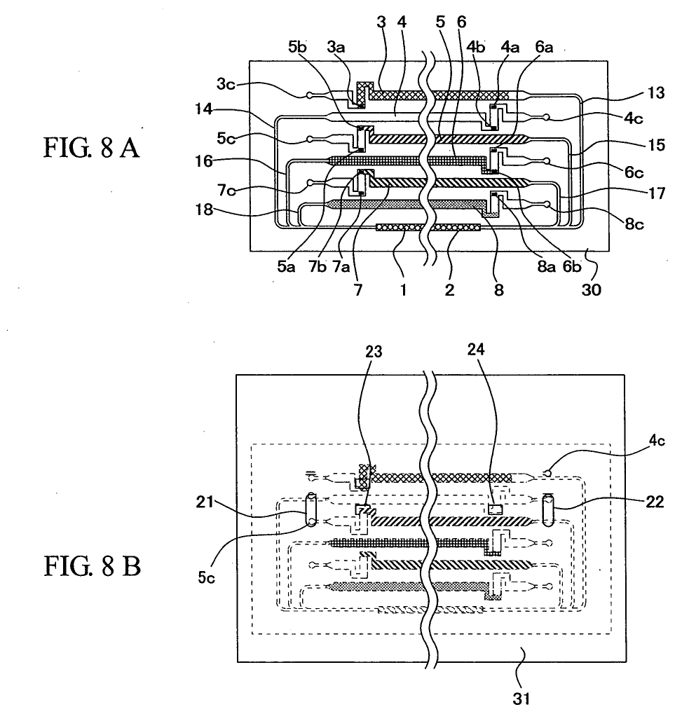

Now referring to FIG. 8 the first washing step will be described in greater details. FIG. 8A shows the test chip 30 prior to first washing process, and FIG. 8B shows the relative positions of the test chip 30 and the cover 31 in the first washing process, and the test chip 30 in doted line.

As shown in FIG. 8A, prior to the first washing step, the waste drain path 3 contains the used sample solution after hybridization, and the sample flow path 4 is empty. The washing solution flow paths 5, 6, 7, and 8 contain respectively the first washing solution, second washing solution, third washing solution, and fourth washing solution. To perform the first washing step, as shown in FIG. 8B, the cover 31 is relatively moved with respect to the test chip 30 so as to align the apertures 21 and 22 on the cover with the delivery ports 5c and 4c. By doing this other delivery ports 3c, 7c, 6c, and 8c are closed, and the solution sensor 23 and 24 are placed at the positions of solution detector units 5b and 4b.

Then the solution delivery is performed in the feeding direction. The delivery port 4c is opened to the air, while the delivery port 5c is applied with a high pressure. The first washing solution contained in the washing solution flow path S flows through the passageway 15 to the reaction flow path 2, and then through the passageway 14 to the sample flow path 4.

Next, the solution delivery is performed in the return direction. Once the washing solution reaches the solution detector unit 4b at the right side end of the sample flow path 4, the solution sensor 24 detects the solution. The solution sensor 24, upon detection of the arrival of the first washing solution at the solution detector unit 4b, transmits the detection to the syringe pump 113.

The syringe pump 113 in turn switches over the valve 105 to apply a high pressure to the delivery port 4c and to open the delivery port 5c to the air. The first washing solution contained in the sample flow path 4 flows back through the passageway 14 to the reaction flow path 2, and then through the passageway 15 to the washing solution flow path 5.

Next, the solution delivery is performed in the feeding direction. When the first washing solution reaches the solution detector unit 5b at the left side end of the washing solution flow path 5, the solution sensor 23 detects the solution. The solution sensor 23, upon detection of the first washing solution at the solution detector unit 5b, transmits the detection to the syringe pump 113.

The syringe pump 113 in turn switches over the valve 105 to apply a high pressure to the delivery port 5c and to open the delivery port 4c to the air. The first washing solution contained in the washing solution flow path 5 flows back through the passageway 15 to the reaction flow path 2 and then through the passageway 14 to the sample flow path 4.

As can be seen from the foregoing description, by switching the valve 105, the solution delivery in the feeding direction and in the return direction can be performed alternately by the predetermined number of cycles. This feeds and returns the first washing solution through the reaction flow path 2. Each time the first washing solution flows through the reaction flow path 2, the probe fixed on the beads is rinsed. When the first washing solution moves to the waste drain path 4 the first washing step terminates.

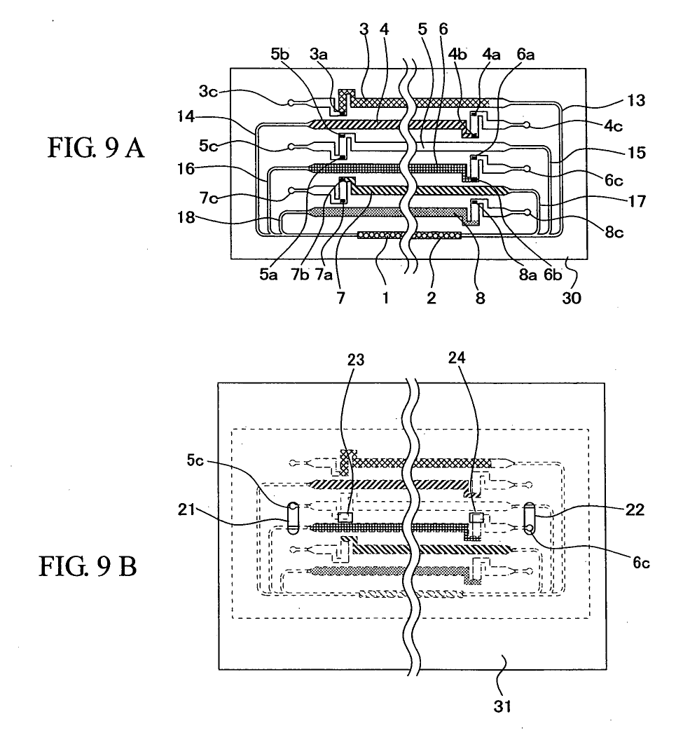

Now referring to FIG. 9, the second washing step will be described in greater details. FIG. 9A shows the test chip 30 prior to the second washing step, and FIG. 9B shows the relative positions of the test chip 30 and the cover 31 at the time of second washing step, where the test chip 30 is shown by dotted line.

As shown in FIG. 9A, prior to the second washing step, the waste drain path 3 contains the used sample solution after hybridization, and the sample flow path 4 contains the used first washing solution after the first washing step. The washing solution flow path 5 is empty. The washing solution flow path 6, 7, and 8 contain the second washing solution, third washing solution, and fourth washing solution, respectively. To perform the second washing step, as shown in FIG. 9B, the cover 31 is relatively moved with respect to the test chip 30 so as to align the apertures 21 and 22 with the positions of delivery ports 5c and 6c. By doing this other delivery ports 3c, 7c, 4c, and 8c are closed, and the solution sensor 23 and 24 are placed at the positions of solution detector units 5a and 6a.

Then, the solution is delivered in the feeding direction. The delivery port 5c is opened to the air and the delivery port 6c is applied with a high pressure. The second washing solution contained in the washing solution flow path 6 flows through the passageway 16 to the reaction flow path 2, and then through the passageway 15 to the washing solution flow path 5.

Next, the solution is delivered in the return direction. The solution sensor 23, upon the arrival of the second washing solution at the solution detector unit 5a at the left side end of the washing solution flow path 5, detects the solution. The solution sensor 23, upon detection of the arrival of the second washing solution at the solution detector unit 5a, transmits the detection to the syringe pump 113.

The syringe pump 113 in turn switches over the valve 105 to apply a high pressure to the delivery port 5c and to open the delivery port 6c to the air. The second washing solution contained in the washing solution flow path 5 flows back through the passageway 15 to the reaction flow path 2, and then through the passageway 16 to the washing solution flow path 6.

Thereafter the solution is delivered in the feeding direction. Once the second washing solution reaches the solution detector unit 6a at the right side end of the washing solution flow path 6, the solution sensor 24 detects the solution. The solution sensor 24 then upon detection of the arrival of the second washing solution at the solution detector unit 6a, transmits the detection to the syringe pump 113.

The syringe pump 113 in turn switches over the valve 105 to apply a high pressure to the delivery port 6c and to open the delivery port 5c to the air. The second washing solution contained in the washing solution flow path 6 flows through the passageway 16 to the reaction flow path 2, and then through the passageway 15 to the washing solution flow path 5.

As can be seen from the foregoing description, by switching the valve 105, the solution delivery in the feeding direction and in the return direction can be performed alternately by the predetermined number of cycles. This feeds and returns the second washing solution through the reaction flow path 2. Each time the second washing solution flows through the reaction flow path 2, the probe fixed on the beads is washed out. The second washing step terminates when the first washing solution moves to the waste drain path 5.

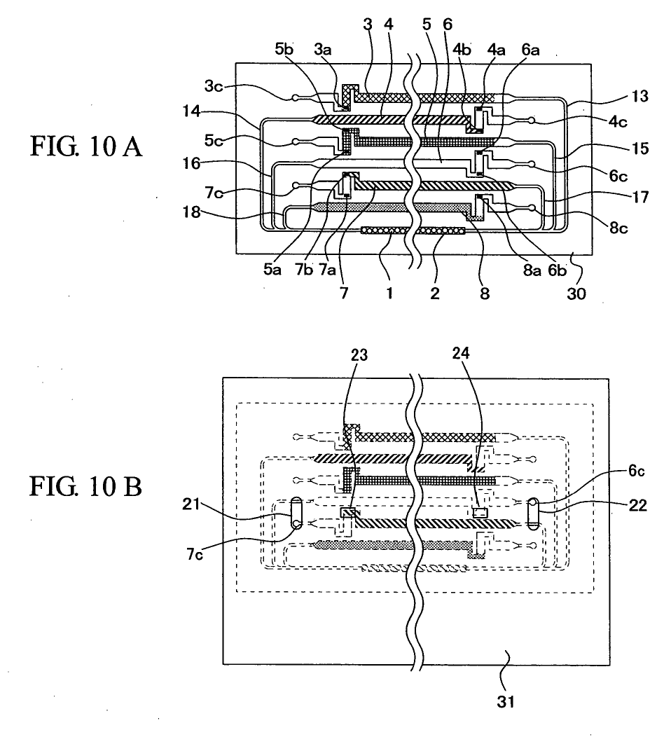

Now referring to FIG. 10, the third washing step will be described in greater details. FIG. 10A shows the test chip 30 prior to the third washing process, and FIG. 10B shows the relative positions of the test chip 30 and the cover 31 at the time of third washing process, where the test chip 30 is shown by a dotted line.

As shown in FIG. 10A, in the third washing process, the waste drain path 3 contains the used sample solution after the hybridization reaction, the sample flow path 4 contains the first washing solution used in the first washing process, and the washing solution flow path 5 contains the second washing solution used in the second washing process. The washing solution flow path 6 is empty. The washing solution flow paths 7 and 8 contain the third washing solution and the fourth washing solution, respectively. To perform the third washing process, as shown in FIG. 10B, the cover 31 is relatively moved with respect to the test chip 30 so as to align the apertures 21 and 22 on the cover with the positions of the delivery ports 7c and 6c, respectively. By doing this other delivery ports 3c, 5c, 4c, and 8c are closed, and the solution sensor 23 and 24 are placed at the positions of solution detector units 7b and 6b.

At first, the solution is delivered in the feeding direction. The delivery port 6c is opened to the air while the delivery port 7c is applied with a high pressure. The third washing solution contained in the washing solution flow path 7 flows through the passageway 17 to the reaction flow path 2, and then through the passageway 16 to the washing solution flow path 6.

Next, the solution is delivered in the return direction. Upon arrival of the third washing solution at the solution detector unit 6b at the right side end of the washing solution flow path 6, the solution sensor 24 detects the solution. The solution sensor 24, upon detection of the arrival of the third washing solution at the solution detector unit 6b, transmits the detection to the syringe pump 113.

The syringe pump 113 in turn switches over the valve 105 to apply a high pressure to the delivery port 6c and to open the delivery port 7c to the air. The third washing solution contained in the washing solution flow path 6 flows back through the passageway 16 to the reaction flow path 2, and then through the passageway 17 to the washing solution flow path 7.

Next, the solution is delivered in the feed path direction. Once the third washing solution reaches the solution detector unit 7b at the left side end of the washing solution flow path 7, the solution sensor 23 detects the solution. The solution sensor 23, upon detection of the arrival of the third washing solution at the solution detector unit 7b, transmits the detection to the syringe pump 113.

The syringe pump 113 in turn switches over the valve 105 to apply a high pressure to the delivery port 7c and to open the delivery port 6c to the air. The third washing solution contained in the washing solution flow path 7 flows back through the passageway 17 to the reaction flow path 2 and then through the passageway 16 to the washing solution flow path 6.

As can be seen from the foregoing description, by switching the valve 105, the solution delivery in the feeding direction and in the return direction can be performed alternately by the predetermined number of cycles. This feeds and returns the third washing solution through the reaction flow path 2. Each time the third washing solution flows through the reaction flow path 2, the probes fixed on the beads are washed out. The third washing process terminates when the third washing solution moves to the washing solution flow path 6.

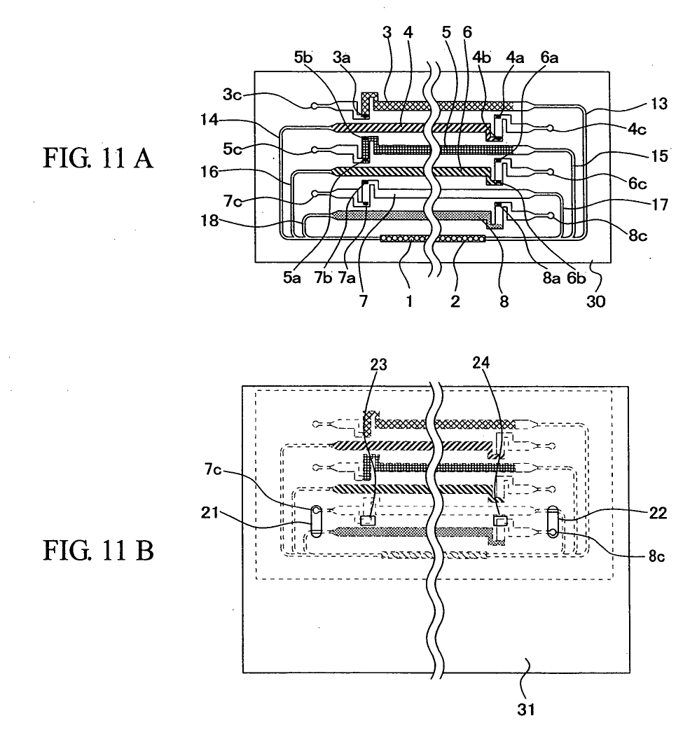

Now referring to FIG. 11, the fourth washing process will be described in greater details. FIG. 11A shows the test chip 30 prior to the fourth washing process, and FIG. 11B shows the relative positions o the test chip 30 and the cover 31, where the test chip 30 is shown by dotted line.

As shown in FIG. 11A, in the fourth washing process, the waste drain path 3 contains the sample solution used in the hybridization reaction, the sample flow path 4 contains the first washing solution used in the first washing process, the washing solution flow path 5 contains the second washing solution used in the second washing process, the washing solution flow path 6 contains the third washing solution used in the third washing process. The washing solution flow path 7 is empty. The washing solution flow path 8 contains the fresh fourth washing solution. To perform the fourth washing process, as shown in FIG. 11B, the cover 31 is moved relatively with respect to the test chip 30 so as to align the apertures 21 and 22 on the cover with the positions of the delivery ports 7c and 8c. By doing this other delivery ports 3c, 5c, 4c, and 6c are closed, and the solution sensors 23 and 24 are placed at the positions of solution detector units 7a and 8a.

At first, the solution is delivered in the feeding direction. The delivery port 7c is opened to the air, and the delivery port 8c is applied with a high pressure. The fourth washing solution contained in the washing solution flow path 8 flows through the passageway 18 to the reaction flow path 2, and then through the passageway 17 to the washing solution flow path 7.

Then the solution is delivered in the return direction. Once the fourth washing solution reaches the solution detector unit 7a at the left side end of the washing solution flow path 7, the solution sensor 23 detects the solution. The solution sensor 23, upon detection of the arrival of the fourth washing solution at the solution detector unit 7a, transmits the detection to the syringe pump 113.

The syringe pump 113 in turn switches over the valve 105 to apply a high pressure to the delivery port 7c and to open the delivery port 8c to the air. The fourth washing solution contained in the washing solution flow path 7 flows back through the passageway 17 to the reaction flow path 2, and then through the passageway 18 to the washing solution flow path 8.

Thereafter, the solution is delivered to the feeding direction. Upon the arrival of the fourth washing solution at the solution detection unit 8a at the right side end of the washing solution flow path 8, the solution sensor 24 detects the solution. The solution sensor 24, upon detection of the arrival of the fourth washing solution at the solution detection unit 8a, transmits the detection to the syringe pump 113.

The syringe pump 113 in turn switches over the valve 105 to apply a high pressure to the delivery port 8c and to open the delivery port 7c to the air. The fourth washing solution contained in the washing solution flow path 8 flows through the passageway 18 to the reaction flow path 2, and then through the passageway 17 to the washing solution flow path 7.

As can be seen from the foregoing description, by switching the valve 105, the solution delivery in the feeding direction and in the return direction can be performed alternately by the predetermined number of cycles. This feeds and returns the fourth washing solution through the reaction flow path 2. Each time the fourth washing solution flows through the reaction flow path 2, the probes fixed on the beads are washed out. The fourth washing process terminates when the fourth washing solution moves back to the washing solution flow path 7.

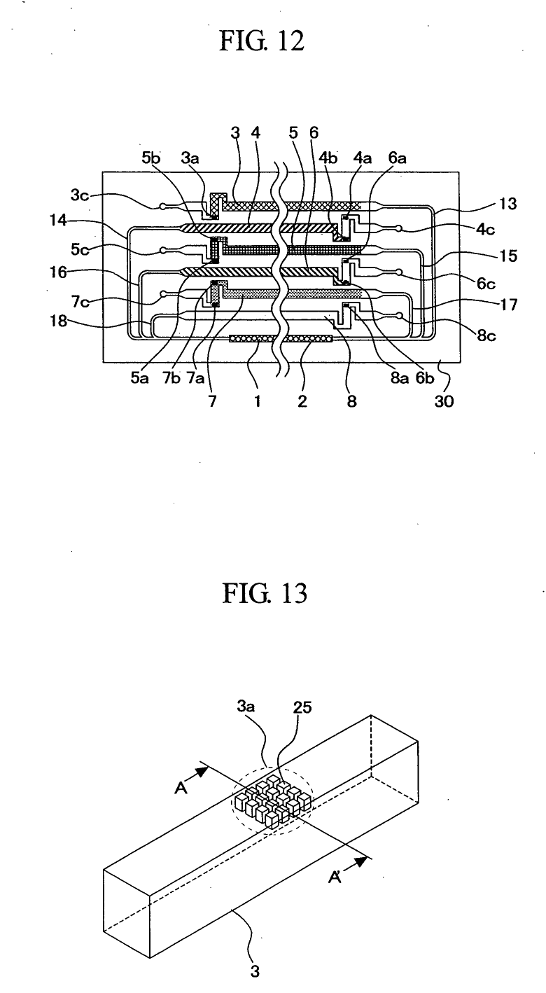

FIG. 12 shows the test chip 30 after the fourth washing process. The waste drain path 3 contains the sample solution used in the hybridization reaction, the sample flow path 4 contains the first washing solution used in the first washing process, the washing solution flow path 5 contains the second washing solution used in the second washing process, the washing solution flow path 6 contains the third washing solution used in the third washing process, and the washing solution flow path 7 contains the fourth washing solution used in the fourth washing process. The washing solution flow path 8 is empty.

In accordance with the preferred embodiment, the sample waste solution and the four washing wastes solution used after their respective washing process, are not drained external to the test chip, but are held in the test chip. This allows the dispositions of sample waste and washing waste solution in a safer and simpler manner.

In accordance with the preferred embodiment, the solution detector units in adjoining passageways are collinearly arranged in line and the solution sensors mounted on the cover are also collinearly arranged in line, so that the one-dimensionally relative displacement of the cover with respect to the test chip allows the solution sensor to be deployed on the adjacent solution detector unit in the neighbor passageway. Therefore the operation and usage of the solution detector units as well as the structure thereof can be simplified and the size may be shrunk.

In accordance with the preferred embodiment, the waste drain path 3, the sample flow path 4, and the washing solution flow paths 5, 6, 7, and 8 has the delivery ports alternately at the left and right ends, and the delivery ports are arranged collinearly and equally spaced apart among them. The apertures on the cover for the purpose to connect the delivery ports to a pressure supply or the atmospheric pressure are collinearly arranged. Accordingly, one-dimensionally relative displacement of the cover with respect to the test chip, forces the waste drain path 3, sample flow path 4, and the washing solution flow paths 5, 6, 7, and 8 to be sequentially connected to the reaction flow path 2, alternately one by one from left or right, according to the order of delivery. Thus, the moving mechanism of the device are simpler so that the downsizing of the device is sufficiently facilitated.

Furthermore in accordance with the preferred embodiment, the waste drain path 3 is provided, which is empty at the initial condition. The sample flow path 4 can be emptied by accommodating the sample waste in the waste drain path 3, and the washing flow path can be emptied by containing washing waste in the sample flow path 4. It can be appreciated that moving the solution wasted after the process into the adjacent empty path makes an empty path one after another. As a result a plurality of processes is allowable by providing the least necessary number of paths.

It should be noted here that although in the preferred embodiment the sample solution and the washing solution are transported bidirectionally in a reciprocating manner, the delivery may be equally unidirectionally in the one-way delivery as needed.

FIG. 13 shows the arrangement of the solution detector unit 3a. Other solution detector units 4a, 4b, 5a, 5b, 6a, 6b, 7a, 7b, and 8a may have the similar structure to the solution detector unit 3a. Accordingly in the following description, only the solution detector unit 3a will be described. The solution detector unit 3a has a fine structure 25 formed on the inner surface of the top side of the waste drain path 3. The fine structure 25 has a plurality of fine projections extending inwardly from the inner wall of the top side of the waste drain path 3 to the inside of the path.

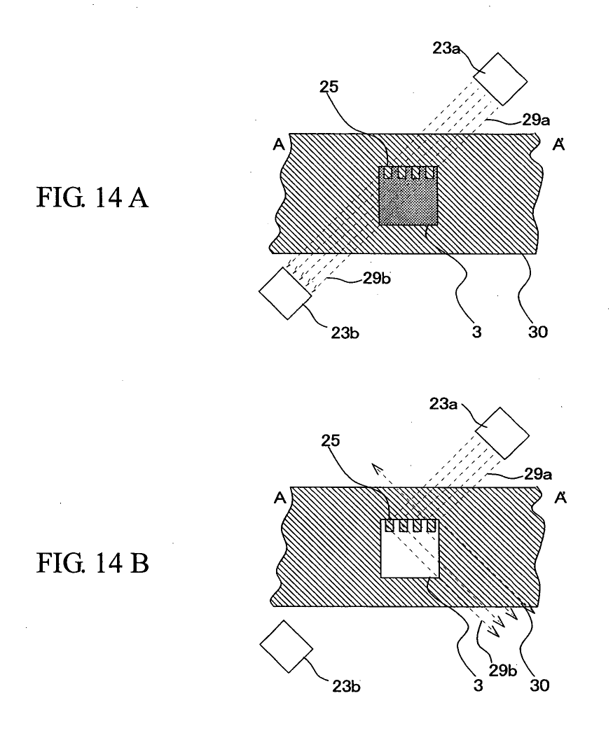

FIG. 14 shows a cross-sectional view of the test chip 30 taken along the arrow A to A′ of FIG. 13 and the solution sensor 23. The solution sensor 24 may have the similar structure to the solution sensor 23. Accordingly only the solution sensor 23 will be described in greater details below. The solution sensor 23 has a light emission unit 23a and a light sensing unit 23b, the fine structure 25 is interposed between them. The solution sensor 23 is placed such that the optical axis does not intersect orthogonally to the external surface of fine projections defining the fine structure 25. In accordance with the preferred embodiment, the fine structure 25 has projections in the form of a cube, the peripheral surface of the projections are perpendicular or in parallel to the external surface of the test chip. Thus, the optical axis of the solution sensor 23 is placed such that it inclines with respect to the external surface of the test chip.

As shown in FIG. 14A, when the waste drain path 3 is filled with the solution, light beam 29a emitted form the light emission unit 23a transmits through the fine structure 25 without refraction. The transmitted light beam 29b reaches the light sensing unit 23b. As shown in FIG. 14B, if the waste drain path 3 is not filled with the solution, more specifically the path is filled with some air or the like, the light beam 29a emitted from the light emission unit 23a will be reflected or scattered at the external surface of the fine projections of the fine structure 25. The light 296 therefore transmitted from the fine structure 25 does not reach the light sensing unit 23b. In this manner the presence or absence of the solution in the solution detector unit 3a can be detected, in accordance with the amount of light received at the light sensing unit 23b.

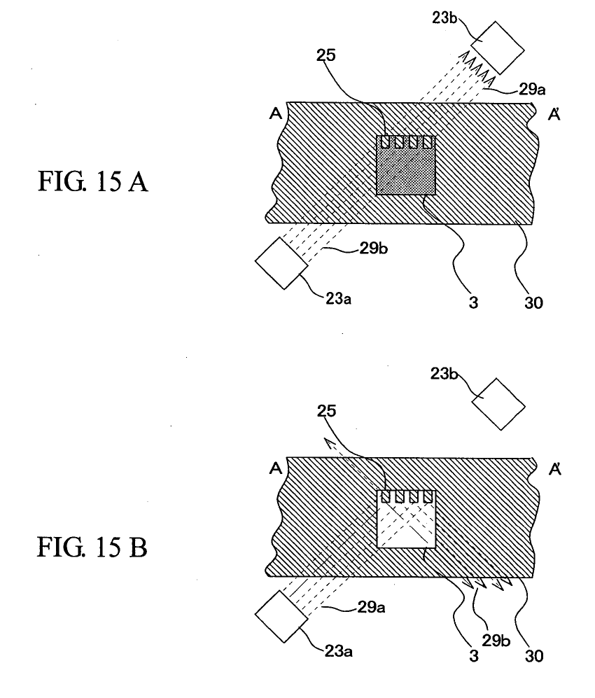

In the embodiment shown in FIG. 14, the light emission unit 23a is mounted on the top of the test chip, more specifically on the side of the fine structure 25, and the light sensing unit 23b is placed on the bottom of the test chip, more specifically on the opposing side to the fine structure 25. However, as shown in FIG. 15, the light sensing unit 23b may be placed on the top of the test chip, namely on the side of the fine structure 25 while the light emission unit 23a may be mounted on the bottom side of the test chip, namely on the side opposed to the fine structure 25.

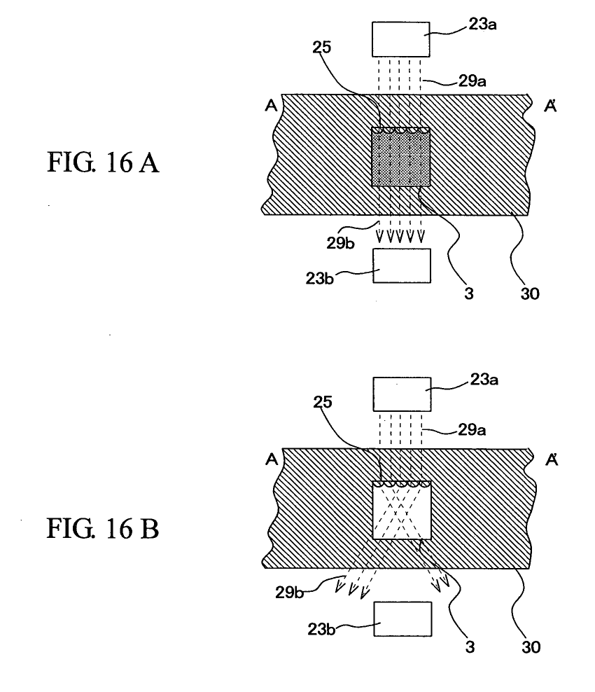

In the embodiment shown in FIG. 16, the fine structure 25 has a number of fine projections of hemispheric or curved surface shape. In the preferred embodiment shown, the solution sensor 23 is placed so that its optical axis is orthogonal to the external surface of the test chip. The optical axis of the solution sensor 23 inclines with respect to the external surface of the projections of the fine structure 25 even in this configuration.

Accordingly, as shown in FIG. 16A, if the waste drain path 3 is filled with the solution, then the light beam 29a emitted from the light emission unit 23a transmits through the fine structure 25 without refraction. The transmitted light beam 29b reaches the light sensing unit 23b. As shown in FIG. 16B, if the waste drain path 3 is not filled with the solution, more specifically the path is filled with some air or the like, the light beam 29a emitted from the light emission unit 23a will be reflected or scattered at the external surface of the fine projections of the fine structure 25 and will not reach the light sensing unit 23b. The light therefore transmitted from the fine structure 25 does not reach the light sensing unit 23b. In this manner the presence or absence of the solution in the solution detector unit 3a can be detected, in accordance with the amount of received light incident upon the light sensing unit 23b.

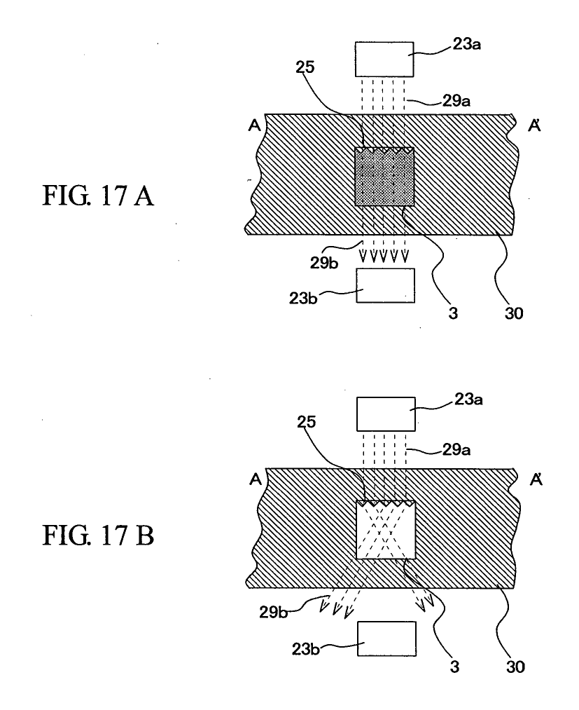

In the embodiment depicted in FIG. 17, the fine structure 25 has a plurality of minute projections in the form of trigonal pyramid or square pyramid. Similarly to the embodiment depicted in FIG. 16, the preferred embodiment has the solution sensor 23 arranged so that its optical axis is perpendicular to the external surface of the test chip.

As shown in FIG. 17A, if the waste drain path 3 is filled with the solution, the light beam 29a emitted from the light emission unit 23a is neither reflected nor scattered by the fine structure 25 and is transmitted. Thus transmitted light 29b reaches the light sensing unit 23b. On the other hand, as shown in FIG. 17B, if the waste drain path 3 is not filled with the solution, the light beam 29b emitted from the light emission unit 23a will be reflected or scattered by the fine structure 25 and will not reach the light sensing unit 23b. The presence or absence of the solution in the solution detector unit 3a can be detected in accordance with the amount of light received by the light sensing unit 23b. It should be noted here that in the embodiment of FIG. 16, a concave section in the shape of hemispheric or curved surface may be provided instead of hemispheric or convex projections. Also in the embodiment shown in FIG. 17, a concave section in the shape of trigonal pyramid or square pyramid may be provided instead of the projections in the shape of trigonal or square pyramid.

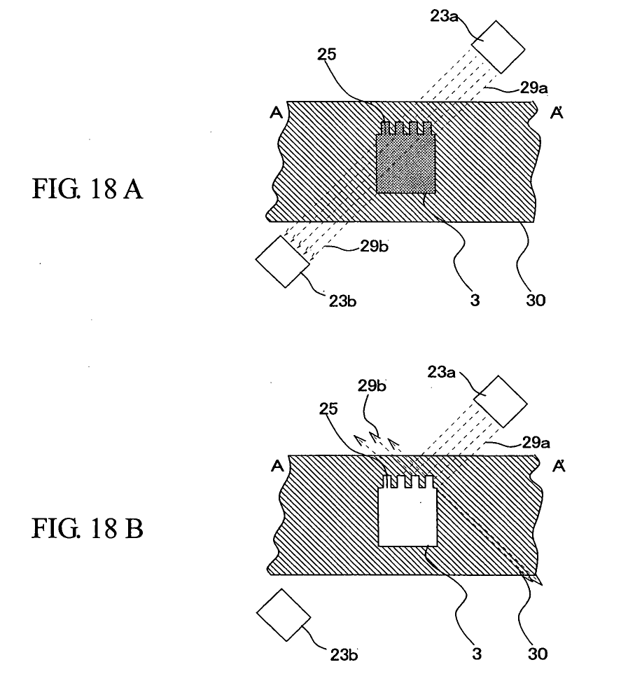

In the preferred embodiment shown in FIG. 18, the fine structure 25 has a number of fine concaved depressions formed on the inner surface of the top of the waste drain path 3. The concaved depressions have a cubic shape and the inner surface of the concaved depression is normal to or in parallel to the external surface of the test chip. Accordingly, in a manner similar to the preferred embodiment shown in FIG. 14, the solution sensor 23 is arranged so that its optical axis is inclined with respect to the external surface of the test chip.

As shown in FIG. 18A, if the waste drain path 3 is filled with the solution, the light beam 29a emitted from the light emission unit 23a will not be reflected nor scattered by the fine structure 25 and will be transmitted. The light beam 29b thus transmitted will reach the light sensing unit 23b. On the other hand, as shown in FIG. 18B, if the waste drain path 3 is not filled with the solution, the light beam 29a emitted from the light emission unit 23a will be reflected or scattered by the fine structure 25 and will not reach the light sensing unit 23b. Accordingly the presence or absence of the solution in the solution detector unit 3a can be detected in accordance with the amount of incident light received by the light sensing unit 23b.

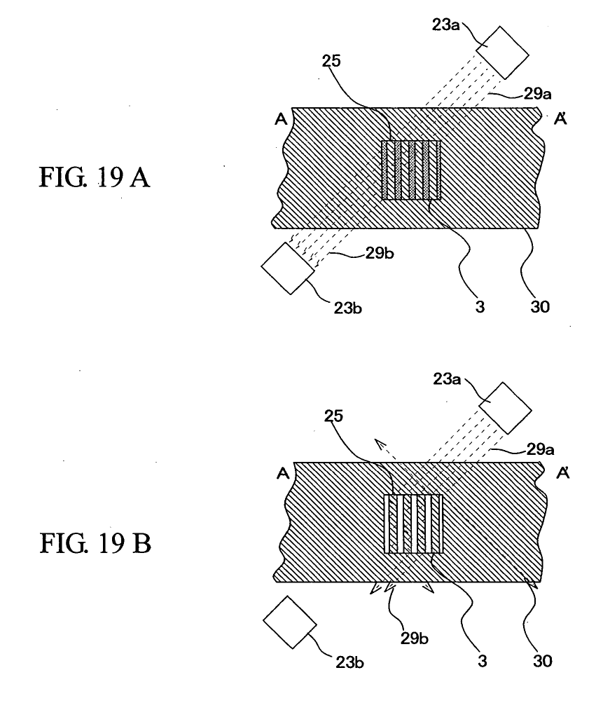

In the preferred embodiment shown in FIG. 19, the fine structure 25 has a plurality of thin cylindrical columns extending from the top to the bottom wall of the fine structure 25. The peripheral surface of the columnar cylinders is normal to the external surface of the test chip. Thus the solution sensor 23 is arranged so that its optical axis is inclined with respect to the external surface of the test chip.

As shown in FIG. 19A, if the waste drain path 3 is filled with the solution, the light beam 29a emitted from the light emission unit 23a will not be refracted by the fine structure 25 and will be transmitted therethrough. On the other hand, as shown in FIG. 19B, if the waste drain path 3 is not filled with the solution, then the light beam 29a emitted from the light emission unit 23a will be reflected or scattered by the fine structure 25 and will not reach the light sensing unit 23b. Accordingly the presence or absence of the solution in the solution detector unit 3a can be detected in accordance with the amount of incident light received by the light sensing unit 23b.

The light sensing unit 23b is a set of optical sensors for detecting the amount of light, however only one single unit of camera having a wide field of view instead of a plurality of light sensing unit. The light sensed by the camera and emitted from all of the light emission units can be detected at the same time by image processing of the video signals output from the camera.

As can be appreciated by those skilled in the art, a plurality of flow paths are subject to detect at the same time based on the video signals fed from only one single camera, allowing facilitating much accurate flow control.

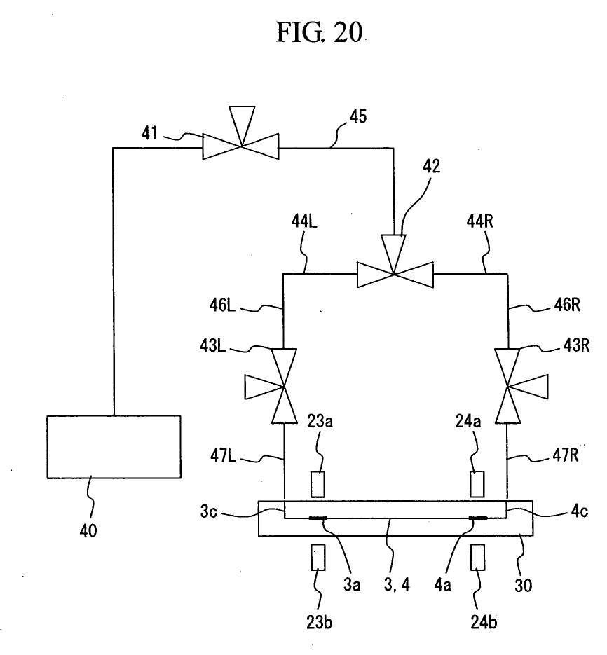

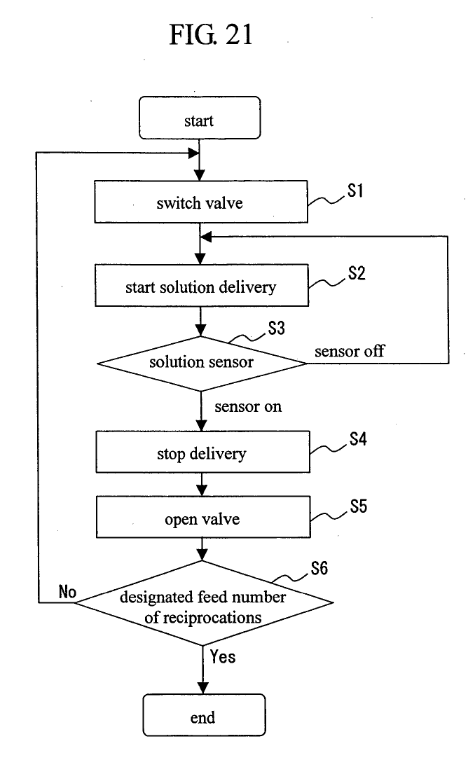

Now an embodiment will be described with reference to FIG. 20 and FIG. 21. Referring to FIG. 20, which shows an overview of the flow control mechanism of the biological material test chip system in accordance with the preferred embodiment; FIG. 21 shows the flow of the operation of the flow control mechanism. In the following a case will be described in which the flow control mechanism is used to conduct the hybridization reaction process as have been described with reference to FIG. 7. As shown in FIG. 20, the flow control mechanism in accordance with the preferred embodiment incorporates a pressure source 40, valves 41, 42, 43L, and 43R, and tubings 45, 46L, 46R, 47L, and 47R. In FIG. 20, only waste drain path 3, sample flow path 4, delivery ports 3c and 4c, solution detector units 3a and 4a of the test chip 30 are depicted schematically in the diagram. Any other flow paths and ports are omitted. On the top of the solution detector units 3a and 4a in the test chip 30, there are arranged light emission units 23a and 24a of the solution sensor 23, and on the bottom thereof there are light reception units 23b and 24b. The cover 31 is not depicted in the figure.

During the delivery of solution, the valve 41 routes the pressure source 40 to the tubing 45. The valve 42 routes the tubing 45 to either tubing 46L or tubing 46R. The valve 43L connects two tubings 46L and 47L mutually, or connects them to the air. The valve 43R connects two tubings 46R and 47R each other, or connects them to the air. The tubing 47L is connected to the delivery port 3c, and the tubing 47R is connected to the delivery port 4c.

First, the solution is delivered in the feeding direction. As shown in FIG. 21, the valve is switched over in step S1. The valve 42 connects the tubing 45 to the tubing 46R, and the valve 43R connects the tubing 46R to the tubing 47R. The pressure source 40 thereby is connected to the delivery port 4c. The valve 43L connects the tubing 46L and the tubing 47L to the air. The delivery port 3c thereby is connected to the air.

The solution is delivered in step S2. The pressure from the pressure source 40 is applied through the tubings 45, 46R, and 47R to the delivery port 4c. The sample solution contained in the sample flow path 4 is thereby pushed out to flow through the reaction flow path 2 to the waste drain path 3.

In step S3 the solution sensor 23 determines whether or not the sample solution reaches the solution detector unit 3a. If the sample solution does not reach it yet, the process goes back to step S2 to continue the solution delivery. Otherwise if the sample solution already reaches there, then the process proceeds to step S4 to stop the solution delivery. The valve 42 switches over to disconnect the tubing 45 from the tubing 46R. In step S5, the valve 43R switches to open the tubings 46R and 47R to the air. In this manner the solution delivery in the feeding direction can be performed.

In step S6, it is determined whether or nor the predefined number of reciprocations is set. If the predefined number of reciprocation is not set then the process terminates. If otherwise the predefined number of reciprocations are set then the process goes back to step S1. In step S1 the valve is switched. The valve 42 connects the tubing 45 to the tubing 46L, the valve 43L connects the tubing 46L to the tubing 47L. The pressure source 40 is thereby connected to the delivery port 3c. The valve 43R connects the tubings 46R and 47R to the air. The delivery port 4c thereby is connected to the air. In step S2, the solution delivery starts. The pressure from the pressure source 40 is routed through tubings 45, 46L, and 47L to the delivery port 3c. The sample solution contained in the waste drain path 3 is pushed out therefrom and flows through the reaction flow path 2 to the sample flow path 4.

In step S3, the solution sensor 24 determines whether or not the sample solution reaches the solution detector unit 4a. If the sample solution is not yet there, then the process goes back to step S2 to continue the solution delivery. If the sample solution reaches then the process proceeds to step S4 to stop the solution delivery. The valve 42 switches to disconnect the tubing 45 from the tubing 46L. In step S5, the valve 43L switches to open the tubings 46L and 47L to the air. In this manner the solution delivery in the return direction is performed.

In step S6, the process terminates when the designated number of reciprocations expires. In the foregoing description although the hybridization reaction process has been described, the washing process follows the same steps.

In the preferred embodiment, the flow is controlled while detecting by the solution sensor whether or not the solution reaches the solution detector unit, allowing performing the flow control of solution more accurately, without observing by the operator the progress of solution displacement in the test chip.

As have been described above, in accordance with the present invention, the test chip, which uses the beads having probes fixed thereon, provides the solution detector units in the flow paths to detect the presence or absence of the solution such as the sample or washing solution therein and to achieve the flow control. The present invention allows more accurate flow control of the solution in the test chip, improving the amount of sample reaction, amount of washing, and the stability thereof in the test chip.

It is to be understood that the present invention is not to be limited to the details herein given but may be modified within the scope of the appended claims.

What is claimed is:

1. A test chip comprising:
a reaction flow path for containing a plurality of beads having mutually different types of probes fixed thereon;
solution flow paths for containing predetermined solutions including a sample solution and washing solution; and
solution detector units for detecting whether or not the solution has been flew into said solution flow path,
wherein a pressure from a pressure supply serves to flow said solutions into said reaction flow path.

2. A test chip in accordance with claim 1, wherein:
said solution detector unit comprises
a fine structure formed in said solution flow path for reflecting or scattering light;
a light emission unit for emitting light to said fine structure; and
a light sensing unit for receiving light emitted from said light emitting unit.

3. A test chip in accordance with claim 2, wherein:
said fine structure comprises fine asperities formed on the inner wall of said solution flow path.

4. A test chip in accordance with claim 2, wherein:
said fine structure comprises projections or depressions in the shape of either fine cube, trigonal pyramid, or square pyramid, formed on the inner wall of said solution flow path.

5. A test chip in accordance with claim 2, wherein:
said fine structure comprises projections or depressions in the shape of fine hemisphere or curved surface, formed on the inner wall of the solution flow path.

6. A test chip in accordance with claim 2, wherein:
said fine structure comprises fine cylindrical columns formed in said solution flow path.

7. A test chip in accordance with claim 1, wherein:
said solution detector unit mounted on two adjacent solution flow paths are collinearly arranged.

8. A test chip in accordance with claim 1, wherein:
at least one of said reaction flow path and said solution flow path is made of PDMS.

9. A test chip in accordance with claim 1, further comprising:
an empty flow path, said empty path being served for flowing sequentially said solutions through said reaction flow path.

10. A test chip system, comprising:
a test chip;
a pressure supply; and
a controller device for connecting the pressure from said pressure supply to said test chip,
wherein
said test chip including:
a reaction flow path for containing a plurality of beads having mutually different types of probes fixed thereon;
solution flow paths for containing predetermined solutions including a sample solution and washing solution; and
a solution detector unit for detecting whether or not a solution has been flowed through said solution flow path;
said controller device supplying the pressure supplied from said pressure supply to said test chip based on the solution detection signal detected by said solution detector unit, so as to flow said solutions sequentially through said reaction flow path.

11. A test chip, comprising:
a reaction flow path for containing a plurality of beads having mutually different types of probes fixed thereon;
first, second, and third delivery ports, connectable to a pressure supply or to the atmospheric pressure;
a waste drain path having one end connected to said first delivery port and the other end connected to said reaction flow path, for containing the used sample solution;
a sample flow path having one end connected to said second delivery port and the other end connected to said reaction flow path for containing a sample solution;
a washing solution flow path having one end connected to said third delivery port and the other end connected to said reaction flow path for containing washing solution; and
a solution detector unit provided in each of said sample flow path, said waste drain path and said washing solution flow path for detecting whether or not the solution has been flowed through said flow paths;
wherein:
two delivery ports of said first, second, and third delivery ports are connected to either the pressure from a pressure supply or to an atmospheric pressure, in accordance with the solution detection signals output from said solution detector unit.

12. A test chip in accordance with claim 11, wherein:
said solution detector unit includes
a fine structure mounted on said solution flow paths for reflecting or scattering the light;
a light emission unit for emitting light to said fine structure; and
a light sensing unit for receiving the light emitted from said light emission unit.

13. A test chip in accordance with claim 11, further comprising
a cover having two apertures,
said two apertures are formed in places corresponding to the locations of delivery ports provided in two adjacent flow paths.
